(19) United States
(12) Patent Application Publication
(10) Pub. No.: US 2026/0147513 A1
(43) Pub. Date: May 28, 2026

(54) MANAGEMENT DEVICE MANAGING EXECUTION SCHEDULE OF PRINT JOB

(71) Applicant: Nobuhiro HARA, Osaka (JP)

(72) Inventor: Nobuhiro HARA, Osaka (JP)

(73) Assignee: KYOCERA Document Solutions Inc., Osaka (JP)

(21) Appl. No.: 19/392,228

(22) Filed: Nov. 18, 2025

(30) Foreign Application Priority Data
Nov. 26, 2024 (JP) 2024-205807

(51) Int. Cl. G06F 3/12

(52) U.S. Cl. CPC G06F 3/1263; G06F 3/1219; G06F 3/1273

(57) ABSTRACT

A management device includes a calculator that calculates a consumption amount of a material resource consumed for a new print job stored in a job queue, and a time required for executing the print job, a decider that decides, on a basis of the consumption amount of the material resource and the time required, a deadline specified in the new print job, a vacant time of a printing device, and predicted availability of the material resource, based on future consumption and replenishment, a scheduled time of day of execution of the new print job, at which the consumption amount of the material resource consumed for the new print job, and the time required, can be secured within the vacant time of the printing device before the deadline, and an updater that updates the execution schedule, according to the scheduled time of day of execution decided by the decider.

### INCORPORATION BY REFERENCE

This application claims priority to Japanese Patent Application No. 2024-205807 filed on Nov. 26, 2024, the entire contents of which are incorporated by reference herein.

### BACKGROUND

The present disclosure relates to a management device that manages an execution schedule of a print job.

Print jobs are normally executed in the order that they were stored (entered) in a job queue. In this relation, some techniques have been developed, to display information required for adjustment of the schedule of the print job, such as a production process or resource information. Further, some techniques to generate the execution schedule of the print jobs, on the basis of availability information of materials necessary for the print job, such as ink and sheets, are also known.

### SUMMARY

The disclosure proposes further improvement of the foregoing technique.

In an aspect, the disclosure provides a management device including a job queue and a control device. The job queue includes a storage region for storing a print job. The control device includes a processor, and acts as a controller, a calculator, a predictor, a decider, and an updater, when the processor executes a control program. The controller executes the print job, according to an execution schedule of the print job stored in the job queue, specified for a printing device. The calculator calculates, on a basis of a new print job stored in the job queue, a consumption amount of a material resource to be consumed for the new print job, and a time required for executing the print job. The predictor calculates a predicted value of an amount of the material resource that can be consumed by the printing device, on a basis of consumption and replenishment of the material resource in future. The decider decides, on a basis of the consumption amount of the material resource and the time required, calculated by the calculator, a deadline specified in the new print job, a vacant time of the printing device, and the predicted amount of the material resource that can be consumed by the printing device, predicted by the predictor, a scheduled time of day of execution of the new print job, at which the consumption amount of the material resource, to be consumed through execution of the new print job, and the time required, can be secured within the vacant time of the printing device before the deadline. The updater updates the execution schedule, according to the scheduled time of day of execution decided by the decider.

### BRIEF DESCRIPTION OF THE DRAWINGS

FIG. 1 is schematic diagram showing an entirety of a printing system, including a management device according to an embodiment of the disclosure;

FIG. 2 is a functional block diagram schematically showing an essential internal configuration of the management device according to the embodiment of the disclosure;

FIG. 3 is a schematic drawing showing an example of an execution schedule of a print job;

FIG. 4 is a flowchart showing a process for adjusting the execution schedule of the print job, performed by the management device;

FIG. 5 is a schematic drawing showing another example of the execution schedule of the print job;

FIG. 6 is a schematic drawing showing another example of the execution schedule of the print job; and

FIG. 7 is a schematic drawing showing another example of the execution schedule of the print job.

### DETAILED DESCRIPTION

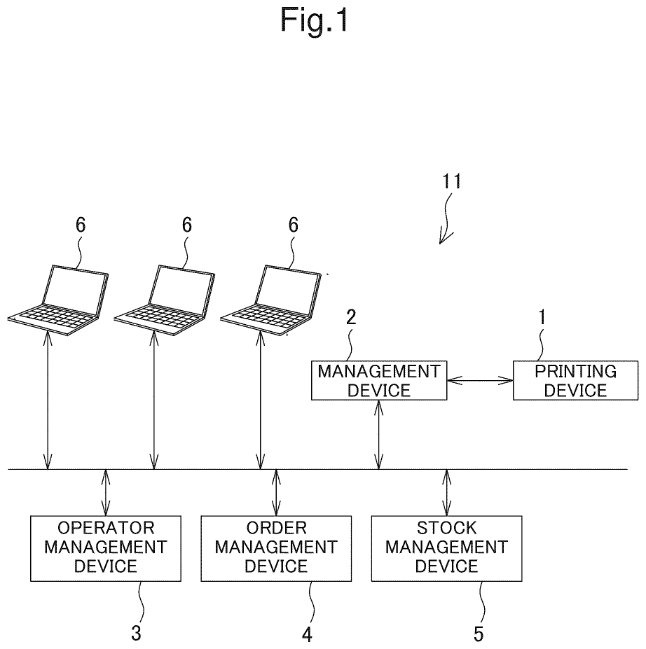

FIG. 1 is schematic diagram showing an entirety of a printing system, including a management device according to an embodiment of the disclosure.

The printing system 11 according to the embodiment of the disclosure includes a printing device 1, a management device 2, an operator management device 3, an order management device 4, a stock management device 5, and a plurality of terminal devices 6, which are located on a network, such as the internet. The printing device 1 has a printer function, and forms an image on a recording medium, for example through an electrophotographic process using a developing agent containing toner of four colors (cyan, magenta, yellow, and black).

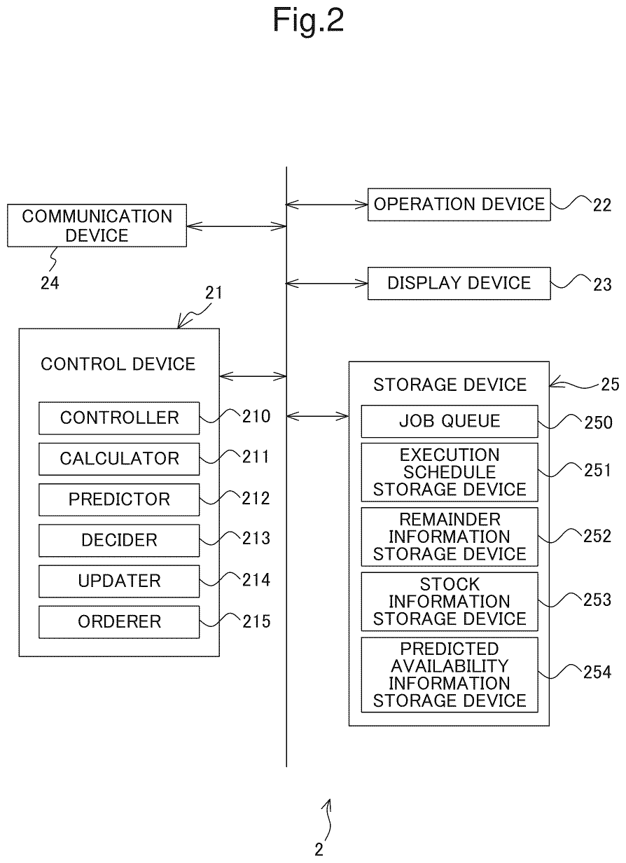

The management device 2 includes a job queue 250 (see FIG. 2) which is a storage region for storing print jobs, and manages an execution schedule, to be subsequently described, for causing the printing device 1 to execute the print job stored in the job queue 250.

The operator management device 3, the order management device 4, and the stock management device 5 each include a computer having a CPU, for example including a processor.

The operator management device 3 manages an operator who performs, for example, maintenance work for the printing device 1, transport of the recording medium, and transport of printed products provided by the printing device 1. The order management device 4 manages ordering of material resources (e.g., toner of each color, recording media, and stapler needles), consumed through the execution of the print job. The stock management device 5 manages stock amounts of the material resources, stored in a storage site such as a warehouse.

FIG. 2 is a functional block diagram schematically showing an essential internal configuration of the management device 2 according to the embodiment of the disclosure. The management device 2 is, for example, a personal computer, and includes a control device 21, an operation device 22, a display device 23, a communication device 24, and a storage device 25. The mentioned components are configured to transmit and receive data and signals to and from each other, via a communication bus.

The operation device 22 includes a keyboard and a mouse, for inputting commands or characters to the control device 21, and also operating a pointer on the screen of the display device 23. The operation device 22 receives, according to an operation made thereon by a user, an input of an instruction from the user. The display device 23 includes, for example, a liquid crystal display (LCD), and displays responses and data results, under the control of a controller 210, to be subsequently described.

The communication device 24 is a communication interface that transmits and receives various types of data to and from an external device (e.g., printing device 1, operator management device 3, order management device 4, stock management device 5, and terminal device 6) located inside the local area, or on the internet.

The storage device 25 is a large-capacity storage device such as a hard disk drive (HDD) or a solid-state drive (SSD), and contains various control programs. In addition, the storage device 25 includes storage regions, each serving as a job queue 250, an execution schedule storage device 251, a remainder information storage device 252, a stock information storage device 253, and a predicted availability information storage device 254.

The job queue 250 stores therein the print jobs, along with the order of reception. The execution schedule storage device 251 stores therein information about the execution schedule of the print job stored in the job queue 250, to be executed by the printing device 1. As an example of the information about the schedule, the order management device 4 transmits, periodically or occasionally, arrival schedule information of the material resource to the management device 2. The controller 210 updates the information stored in the execution schedule storage device 251, each time the arrival schedule information is received.

The remainder information storage device 252 stores therein remainder information indicating the remaining amount in the printing device 1, of the material resources consumed through the execution of the print job (e.g., toner of each color, recording media, stapler needles, and components that have to be replaced after printing a predetermined number of sheets, such as a photoconductor drum). The remainder information is periodically or occasionally transmitted from the printing device 1. The controller 210 updates the information stored in the remainder information storage device 252, each time the remainder information is received.

The stock information storage device 253 stores therein stock information indicating the stock amount in the storage site (e.g., warehouse), of the material resources consumed through the execution of the print job. The stock information is periodically or occasionally transmitted from the stock management device 5. The controller 210 updates the information stored in the stock information storage device 253, each time the stock information is received.

The predicted availability information storage device 254 stores therein predicted availability information, indicating the predicted amount of the material resources that can be consumed by the printing device 1, predicted by a predictor 212 to be subsequently described. The predicted availability represents the total sum of the remaining amount of the material resources in the printing device 1, and the stock amount of the material resources in the storage site.

The control device 21 includes a processor, a random-access memory (RAM), a read-only memory (ROM), and an exclusive hardware circuit. The processor is, for example, a central processing unit (CPU), an application specific integrated circuit (ASIC), or a micro processing unit (MPU). The control device 21 includes the controller 210, a calculator 211, the predictor 212, a decider 213, an updater 214, and an orderer 215.

To be more specific, the control device 21 acts as the controller 210, the calculator 211, the predictor 212, the decider 213, the updater 214, and the orderer 215, when the processor operates according to the control program stored in the storage device 25. Here, the controller 210 and other components may be constituted in the form of a hardware circuit, instead of being realized by the operation of the control device 21 according to the control program. This also applies to other embodiments, unless otherwise specifically noted.

The controller 210 serves to control the overall operation of the management device 2. The controller 210 is connected to the operation device 22, the display device 23, the communication device 24, and the storage device 25, and controls the operation of the mentioned components. For example, the controller 210 stores, upon receipt of an execution request of the print jobs, transmitted from the terminal device 6 via the communication device 24, the received print jobs in the job queue 250, and transmits the print jobs to the printing device 1, according to the execution timing of the print jobs indicated by the execution schedule, thereby causing the printing device 1 to execute the print jobs. The print job includes various types of information necessary for the execution of the printing operation, such as the number of pages to be printed, the number of copies, the sheet size, distinction between color and B/W, layout, and density, and also information indicating a deadline, by which the print job has to be completed.

The calculator 211 calculates, on the basis of new print job stored in the job queue 250, and the capacity of the printing device 1 (e.g., printing speed) stored in advance, a consumption amount C of the material resources to be consumed through the execution of the new print job (e.g., toner of each color, recording media, stapler needles, and components that have to be replaced after printing a predetermined number of sheets, such as a photoconductor drum), and a time required T for the execution of the new print job. For example, the calculator 211 analyzes the new print job, and calculates the consumption amount C of the material resources and the time required T, on the basis of the performance level of the printing device 1 (e.g., toner consumption rate and printing speed).

The predictor 212 calculates predicted availability of the material resources, in other words the amount of the material resources that can be consumed by the printing device 1, on the basis of consumption and replenishment of the material resources in the future. As described above, the predicted availability represents the total sum of the remaining amount of the material resources in the printing device 1, and the stock amount of the material resources in the storage site.

For example, when the predicted availability is 9000 sheets, and the execution of a print job that consumes 1000 sheets is scheduled, the predictor 212 reduces the predicted availability after the execution of the print job by 1000 sheets, thereby newly calculating the predicted availability as 8000 sheets. As another example, when 100000 sheets are to arrive, the predictor 212 newly calculates the predicted availability after the scheduled date of arrival, by adding 100000 sheets, on the basis of the information indicating the arrival of 100000 sheets.

The decider 213 decides, on the basis of the consumption amount C of the material resources and the time required T, calculated by the calculator 211, the deadline specified in the new print job, the vacant time of the printing device 1, and the predicted availability of the material resources to the printing device 1, predicted by the predictor 212, the scheduled time of day of execution of the new print job, at which the consumption amount C of the material resources, to be consumed through the execution of the new print job, and the time required T, can be secured within the vacant time of the printing device 1 before the deadline. The decider 213 acquires the vacant time of the printing device 1 from the information stored in the execution schedule storage device 251, and acquires the predicted availability of the material resources from the information stored in the predicted availability information storage device 254. In this embodiment, the decider 213 determines the earliest time of day as the scheduled time of day of execution, among the times of day that may be set as the scheduled time of day of execution.

Upon deciding that the time of day at which both of the consumption amount C and the time required T can be secured is unable to be determined, the decider 213 changes the scheduled time of day of execution of the print jobs currently standing by for the execution, thereby determining the scheduled time of day of execution of the new print job, with priority.

The updater 214 updates the execution schedule stored in the execution schedule storage device 251, each time the decider 213 determines the scheduled time of day of execution of the print job.

The orderer 215 executes a predetermined ordering operation, necessary for ordering the material resources. For example, the orderer 215 issues the order to the order management device 4, according to the instruction inputted by the user through the operation device 22.

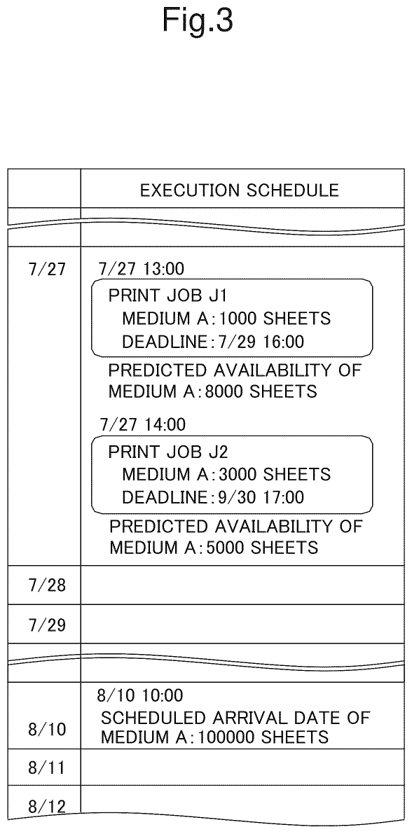

FIG. 3 is a schematic drawing showing an example of the execution schedule of the print job. This example indicates that 13:00 on July 27 is the scheduled time of day of execution of a print job J1, and 14:00 on July 27 is the scheduled time of day of execution of a print job J2. This example also indicates that the consumption amount of a medium A (e.g., plain paper of A4 size) by the print job J1 is 1000 sheets, that the deadline of the print job J1 is 16:00 on July 29, that the consumption amount of the medium A by the print job J2 is 3000 sheets, and that the deadline is 17:00 on September 30. Here, the print job, the scheduled time of day of execution of which is set at the nearest time in the execution schedule, is deleted from the execution schedule, once the execution is completed. In this embodiment, accordingly, the print job the scheduled time of day of execution of which is set at the nearest time in the execution schedule is regarded as being executed, provided that the environment that enables the printing operation is established at the time that the schedule is set.

Further, this example indicates that the predicted availability of the medium A is decreased to 8000 sheets, through the execution of the print job J1, and to 5000 sheets through the execution of the print job J2, and that 100000 sheets of medium A are scheduled to arrive, at 10:00 on August 10.

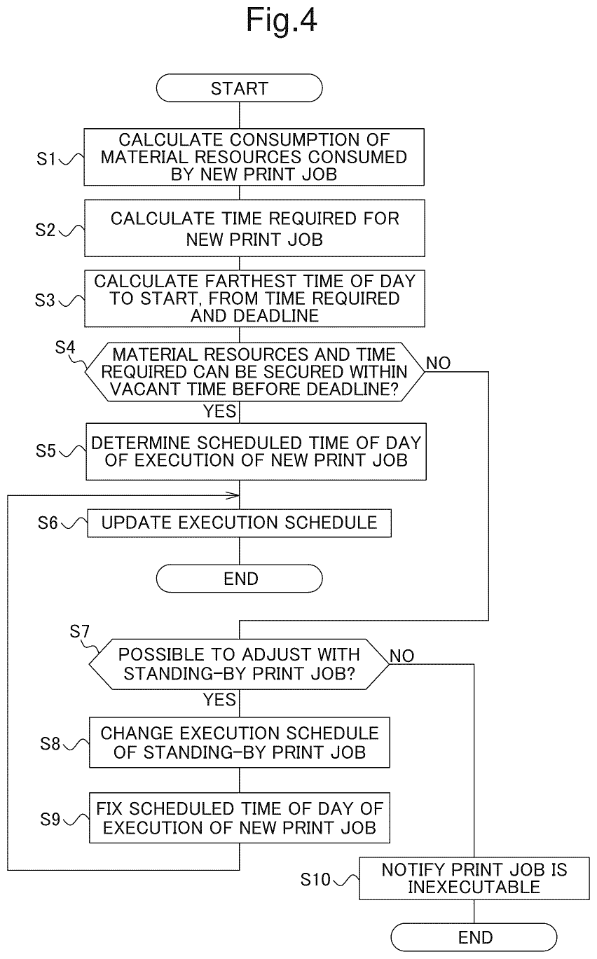

Referring now to a flowchart shown in FIG. 4, an example of an operation, performed by the management device 2 to adjust the execution schedule of the print job, will be described hereunder. This operation is performed when a new print job is stored in the job queue 250.

The calculator 211 calculates the consumption amount C of the material resources, consumed through the execution of the new print job stored in the job queue 250 (S1), and also the time required T for the execution of the new print job (S2). Then the calculator 211 calculates the latest time of day that the new print job has to be started, in order to complete the printing operation before the deadline, on the basis of the time required T calculated, and the deadline specified in the print job (S3). For example, when the deadline is 16:00 on July 29, and the time required T is 60 minutes, the calculator 211 calculates the latest time of day to start as 15:00 on July 29. Here, the calculator 211 may calculate the time required T, by adding a predetermined transport time, necessary for an operator to deliver the printed products provided by the printing device 1 to a predetermined location.

Thereafter, the decider 213 decides, on the basis of the consumption amount C of the material resources and the time required T, calculated by the calculator 211, the deadline specified in the new print job, the vacant time of the printing device 1, and the predicted availability of the material resources to the printing device 1, whether the consumption amount C of the material resources, to be consumed through the execution of the new print job, and the time required T, can be secured within the vacant time of the printing device 1 before the deadline (S4).

Upon deciding that both of the consumption amount C and the time required T can be secured (YES at S4), the decider 213 determines the scheduled time of day of execution of the new print job (S5). Then the updater 214 updates the execution schedule, according to the scheduled time of day of execution determined by the decider 213 (S6). Thereafter, the operation is finished.

Here, the decider 213 extracts all time zones in which the consumption amount C of the material resources, to be consumed through the execution of the new print job, and the time required T, can be secured within the vacant time of the printing device 1 before the deadline. In this embodiment, the decider 213 selects the time that enables the print job to be completed earliest within the deadline, among the extracted time zones, as the scheduled time of day of execution. Accordingly, the controller 210 may immediately transmit the print job through the communication device 24 to the printing device 1, and the printing device 1 may immediately execute the print job, at the time point that the decider 213 has determined the scheduled time of day of execution, and the updater 214 has updated the execution schedule.

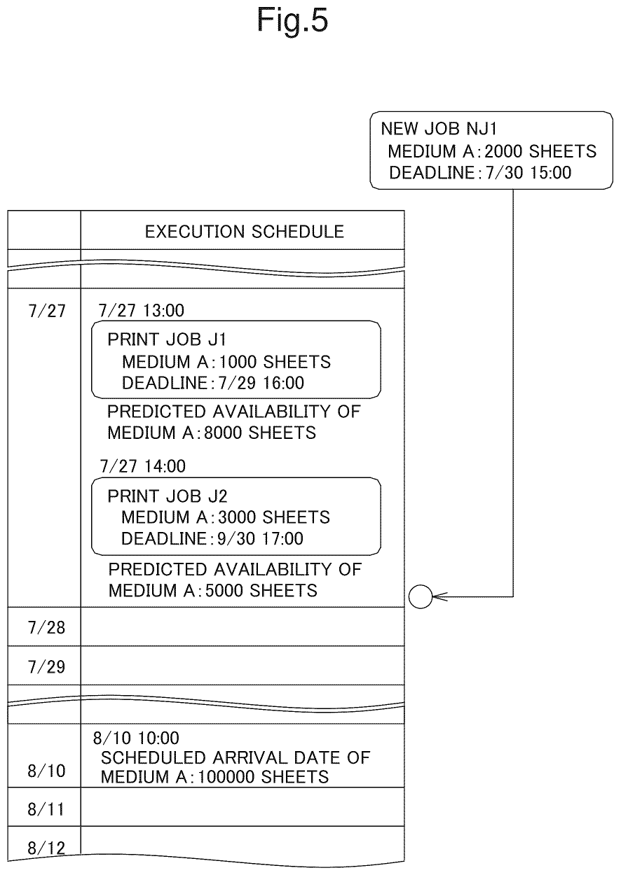

Referring to FIG. 5, for example when the print job J1 the scheduled time of day of execution of which is 13:00 on July 27, and the print job J2 the scheduled time of day of execution of which is 14:00 on July 27, are already specified in the execution schedule as preceding print jobs, and the consumption amount of the medium A through the execution of a new print job NJ1 is 2000 sheets (calculated by the calculator 211 on the basis of number of pages to be printed and the number of copies to be printed), the deadline of the new print job NJ1 being set to 15:00 on July 30, the decider 213 decides that the time required T for the new print job NJ1 can be secured after the second print job J2 is completed, and that the consumption amount C of the material resources to be consumed through the execution of the new print job NJ1 can also be secured, because the predicted availability of the medium A after the completion of the print job J2 is 5000 sheets.

In contrast, upon deciding that at least one of the consumption amount C and the time required T are unable to be secured (NO at S4), the decider 213 decides whether the scheduled time of day of execution of the new print job can be secured, by changing the scheduled time of day of execution of the print jobs currently standing by for the execution (S7).

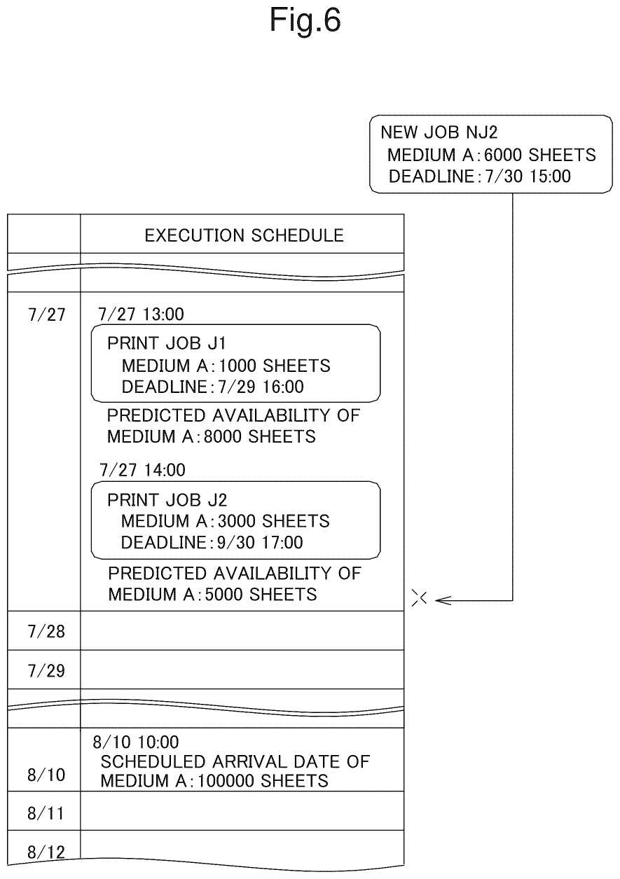

Referring to FIG. 6, for example when the print job J1 the scheduled time of day of execution of which is 13:00 on July 27, and the print job J2 the scheduled time of day of execution of which is 14:00 on July 27, are already specified in the execution schedule as preceding print jobs, and the consumption amount of the medium A through the execution of a new print job NJ2 is 6000 sheets, the deadline of the new print job NJ2 being set to 15:00 on July 30, the decider 213 decides that, although the time required T for the new print job NJ2 can be secured after the second print job J2 is completed, the consumption amount C of the material resources to be consumed through the execution of the new print job NJ2 is unable to be secured. This is because the predicted availability of the medium A is 5000 sheets, which is fewer by 1000 sheets, than the amount to be consumed through the execution of the new print job NJ2.

In this case, as shown in FIG. 6, although the scheduled time of day of execution of the print job J2 is set to 14:00 on July 27, the deadline of the print job J2 is 17:00 on September 30, and there is plenty of time. In addition, the medium A is scheduled to arrive at 10:00 on August 10, which is earlier than the deadline of the print job J2 of 17:00 on September 30. In other words, even though the time of day of execution of the print job J2 is postponed to a point beyond 10:00 on August 10 when the medium A is scheduled to arrive, the print job J2 can be completed before the deadline, and the consumption amount of the material resources and the time required for the print job J2 can both be secured. Therefore, the decider 213 changes the time of day of execution of the print job J2 to a predetermined time point subsequent to 10:00 on August 10. As result, the material resources originally allocated to the print job J2 can be allocated to the new print job NJ2, so that the consumption amount C of the material resources to be consumed through the execution of the new print job NJ2 can be secured.

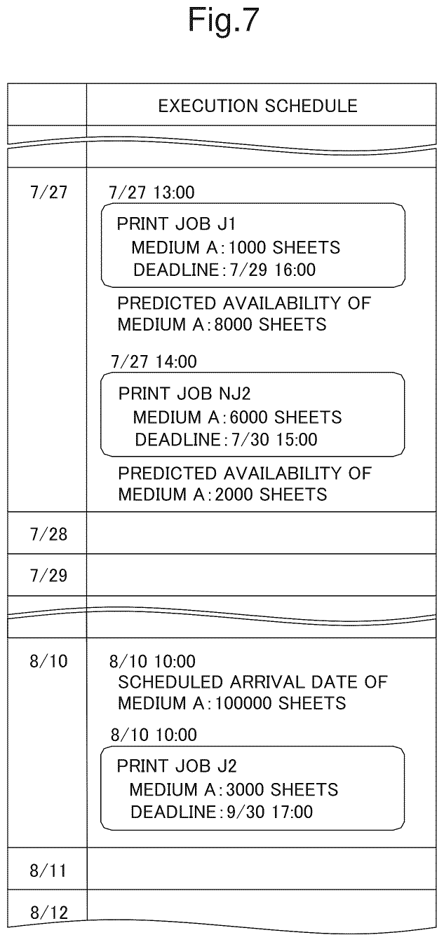

Upon deciding that the scheduled time of day of execution of the new print job can be set, by changing the scheduled time of day of execution of the print job standing by for the execution as above (YES at S7), the decider 213 changes the scheduled time of day of execution of the standing-by print job (S8), and determines the scheduled time of day of execution of the new print job (S9). The decider 213 adopts the earliest time that the print job NJ2 can be executed, as the scheduled time of day of execution of the print job NJ2. In this example, as shown in FIG. 7, the decider 213 sets 14:00 on July 27, which was originally the scheduled time of day of execution of the print job J2, as the scheduled time of day of execution of the print job NJ2.

Then the updater 214 updates the execution schedule, according to the scheduled time of day of execution determined by the decider 213 (S6). Thereafter, the operation is finished.

FIG. 7 illustrates another example of the execution schedule of the print job. According to FIG. 7, the execution schedule of the print job J2 has been changed to 10:00 on August 10, corresponding to the scheduled arrival date of the medium A, and the new print job NJ2 is scheduled to be executed at 14:00 on July 27. FIG. 7 also indicates that the predicted availability of the medium A becomes 2000 sheets, after the execution of the new print job NJ2.

When the decider 213 decides that the scheduled time of day of execution of the new print job is unable to be set, despite changing the scheduled time of day of execution of the print job standing by for the execution (NO at S7), the controller 210 transmits, through the communication device 24, the information indicating that the print job is unable to be completed before the deadline, to the terminal device 6 which is the transmission source of the new print job (S10). Thereafter, the operation is finished.

According to this embodiment, the scheduled time of day of execution of the new print job, at which the consumption amount C of the material resources and the time required T can both be secured, within the vacant time of the printing device 1 before the deadline, is determined, and the execution schedule is updated accordingly. Therefore, an appropriate execution schedule can be created, according to the consumption amount C of the material resources to be consumed through the execution of the print job, and the time required T for the print job. According to this embodiment, further, the execution schedule of the print job can be accurately determined, on the basis of the consumption amount of the material resources to be consumed through the execution of the print job, the time required for the print job, and the scheduled time of day of execution of other print jobs.

Whereas the predicted availability is defined as the total sum of the amount of the material resources remaining in the printing device 1, and the stock amount in the storage site (e.g., warehouse), in the foregoing embodiment, an operator has to transport the material resources stored in the storage site to the printing device 1, and set the material resources therein, to make the material resources usable by the printing device 1.

Accordingly, as another embodiment, the predictor 212 acquires progress information, indicating the progress in the operation of transporting the material resources from the storage site to the printing device 1, and setting the material resources therein, and calculates the predicted availability, by adding the amount of the material resources indicated by the progress information, to the stock amount in the storage site. For example, when one operator transports 10000 sheets per hour, it takes ten hours for this operator to transport 100000 sheets. Accordingly, when two operators can be secured for the transport work, 20000 sheets of material resources can be added, when an hour has elapsed after the start of the work, and 40000 sheets can be added, when two hours have elapsed after the start of the work. In other words, in order to add 100000 sheets to the predicted availability, five hours have to elapse.

In addition, since the transport of the material resources is not the only task of the operator, it is not always possible to secure the operator, at the same time that the material resources have arrived. Accordingly, the predictor 212 acquires the number of operators available for the transport of the material resources, from the work schedule managed by the operator management device 3, and calculates the replenishable amount, representing the progress in the operation of transporting the material resources, on the basis of the acquired number of operators, and the amount that an operator can transport per hour. Then the predictor 212 calculates the predicted availability, by adding the replenishable amount to the stock amount in the storage site.

Further, the time required for transporting the printed products provided by the printing device 1 to a predetermined destination may also be added to the time required T for the execution of the new print job. Such transporting time is calculated on the basis of the ability of the operator.

The calculator 211 acquires work information indicating the progress in the operation of transporting the printed products provided by the printing device 1 to the predetermined destination, and calculates the time required T by adding the time indicated by the work information. For example, when an operator transports 1000 sheets per hour, and three operators can be secured for the transport work, all the printed products (6000 sheets) can be delivered to the predetermined destination, when two hours have elapsed after the start of the work.

Further, since the transport of the printed products is not the only task of the operator, it is not always possible to secure the operator, at the same time that the printing operation has finished. Accordingly, the calculator 211 acquires the number of operators available for the transport of the printed products, from the work schedule managed by the operator management device 3, and calculates the transport amount and the working time, representing the progress in the operation of transporting the printed products, on the basis of the acquired number of operators, and the amount that an operator can transport per hour. Then the calculator 211 calculates the time required T, by adding the working time calculated as above.

In the printing device 1, irregular events may occur, such as occurrence of paper jam, or a malfunction that requires maintenance work. Accordingly, the controller 210 stores an occurrence history of predetermined events that disturb the execution of the print job, in a non-volatile memory incorporated in the control device 21. The calculator 211 calculates occurrence frequency of the events on the basis of the occurrence history, and also a downtime of the printing device 1 that may arise in the future, on the basis of the occurrence frequency. Then the calculator 211 calculates the time required T, by adding the downtime calculated as above. Alternatively, the calculator 211 may calculate the vacant time of the printing device 1, without taking the downtime into account.

As still another embodiment, when the decider 213 decides that the scheduled time of day of execution at which the consumption amount C can be secured is unable to be determined, the orderer 215 executes a predetermined operation for ordering the material resources, the consumption amount C of which is unable to be secured. For example, the orderer 215 makes up an e-mail including an order of a predetermined number of recording sheets addressed to a predetermined supplier, and transmits such e-mail to the mail address of the supplier, via the communication device 24. Therefore, the material resources that are short can be ordered without delay.

In the case of existing devices for managing the print job, different from the foregoing embodiment, the user has to manually adjust the schedule. In addition, although the existing device is configured to generate, as described earlier, the availability information of the materials used for the print job, and the execution schedule of the print job, the device is unable to secure the material resources such as the ink and recording sheets, and to accurately determine the execution schedule of the print job, in consideration of the scheduled time of day of execution of other print jobs.

According to the foregoing embodiment, in contrast, the execution schedule of the print job can be accurately determined, on the basis of the consumption amount of the material resources to be consumed through the execution of the print job, the time required for the execution of the print job, and the scheduled time of day of execution of other print jobs.

The disclosure may be modified in various manners, without limitation to the foregoing embodiment. Further, the configurations and processings according to the embodiment, described with reference to FIG. 1 to FIG. 7, are merely exemplary, and in no way intended to limit the disclosure to those configurations and processings.

While the present disclosure has been described in detail with reference to the embodiments thereof, it would be apparent to those skilled in the art that various changes and modifications may be made therein within the scope defined by the appended claims.

What is claimed is;

1. A management device comprising:
a job queue including a storage region for storing a print job; and
a control device including a processor, and configured to act, when the processor executes a control program, as:
a controller that executes the print job, according to an execution schedule of the print job stored in the job queue, specified for a printing device;
a calculator that calculates, on a basis of a new print job stored in the job queue, a consumption amount of a material resource to be consumed for the new print job, and a time required for executing the print job;
a predictor that calculates a predicted value of an amount of the material resource that can be consumed by the printing device, on a basis of consumption and replenishment of the material resource in future;
a decider that decides, on a basis of the consumption amount of the material resource and the time required, calculated by the calculator, a deadline specified in the new print job, a vacant time of the printing device, and the predicted amount of the material resource that can be consumed by the printing device, predicted by the predictor, a scheduled time of day of execution of the new print job, at which the consumption amount of the material resource, to be consumed through execution of the new print job, and the time required, can be secured within the vacant time of the printing device before the deadline; and
an updater that updates the execution schedule, according to the scheduled time of day of execution decided by the decider.

2. The management device according to claim 1,
wherein, upon deciding that the scheduled time of day of execution, at which both of the consumption amount and the time required can be secured, is unable to be determined, the decider changes the scheduled time of day of execution of a print job standing by for the execution, and determines the scheduled time of day of execution of the new print job, with priority.

3. The management device according to claim 1,
wherein the predictor calculates a total sum of an amount of the material resource remaining in the printing device, and a stock amount of the material resource in a storage site, as a predicted value of the predicted availability.

4. The management device according to claim 3,
wherein the predictor acquires progress information, indicating a progress in operation of transporting the material resource from the storage site to the printing device, and setting the material resource therein, and calculates the predicted value of the predicted availability, by adding an amount indicated by the progress information to the stock amount in the storage site.

5. The management device according to claim 1,
wherein the calculator acquires work information indicating a progress in operation of transporting printed products provided by the printing device to a predetermined location, and calculates the time required by adding a working time indicated by the work information.

6. The management device according to claim 1,
wherein, when the processor executes the control program, the control device further acts as an orderer that executes, when the decider decides that the scheduled time of day of execution at which the consumption amount can be secured is unable to be determined, a predetermined operation for ordering the material resource, the consumption amount of which is unable to be secured.

7. The management device according to claim 1,
wherein the controller stores an occurrence history of predetermined events that disturb the execution of the print job, and
the calculator calculates a downtime of the printing device that may arise in future, on a basis of occurrence frequency of the events calculated from the occurrence history of the events, and calculates the time required, by adding the calculated downtime.
